(19) United States
(12) Patent Application Publication
(10) Pub. No.: US 2005/0223578 A1
(43) Pub. Date: Oct. 13, 2005

(54) Spirit level configured with marking indicia for use in determining correct on-center stud locations

(76) Inventor: Dane Scarborough, Hailey, ID (US)

Correspondence Address: STEPHEN M. NIPPER;DYKAS, SHAVER & NIPPER, LLP, PO BOX 877, BOISE, ID, 83701-0877, US

(21) Appl. No.: 11/101,146

(22) Filed: Apr. 6, 2005

Related U.S. Application Data
(60) Provisional application No. 60/562,137, filed on Apr. 13, 2004.

(51) Int. Cl. G01C 9/00

(52) U.S. Cl. 33/451

(57) ABSTRACT

A carpentry tool having a body, at least one bubble vial, a first marking indicia mark and a second marking indicia mark. The body generally parallelepipedal in shape, having a first end opposite a second end, a top level side opposite a bottom level side and a front face side opposite a back face side. The top level side having a measurement scale which sequentially increases in value from the first end to the second end. The bubble vial mounted within the level body, the bubble vial for indicating when a flat level side is oriented in a substantially horizontal position, the level bubble vial viewable through the front face. The marking indicia marks sixteen-inches or twenty-four-inches apart thereby signifying to a user the on-center measurements of wall studs.

### PRIORITY

This application is a non-provisional of and claims priority date from the provisional application entitled GRAPHICS LEVEL filed by Dane Scarborough on Apr. 13, 2004 with application Ser. No. 60/562,137, the disclosure of which is incorporated herein by reference.

### BACKGROUND

1. Field of the Invention

The present invention generally relates to spirit levels, and more particularly relates to spirit levels with integral measuring functions.

2. Background of the Invention

When framing a wall in the building industry, a construction worker will often use a spring wound tape measure for laying out the appropriate on-center measurement of the studs within the wall. Typically, such studs are located sixteen inches or twenty-four inches on-center.

To facilitate this layout, steel tape measure manufacturers have traditionally included a mark upon such steel tapes every sixteen inches to indicate to a user the location of the sixteen-inch (and/or 24-inch) on-center studs when framing and performing other tasks. However, using a steel tape measure to layout such stud placement can often be a challenge due to the flexible nature of the tape itself and is not as convenient as using a template. Additionally, while the stud center placement may be indicated by marks on the tape, mental computation must be made by the user to determine the width of the stud.

Spirit levels, also known as bubble levels, frequently have a topside bearing a measuring scale which increases from a first end to a second end. One problem with such a scale located on the topside is the fact that they are prone to wear, thereby quickly rendering the topside useless or inaccurate for measuring purposes. Levels are typically placed upon a surface to determine whether the surface is level. Based on how levels are configured, the level surface that contacts the surface to be leveled is the top and/or bottom sides of the level. Sliding the level upon these top/bottom sides (which commonly occurs in the use of a level) causes the marking scale/indicia to soon wear off or become less legible and prone to error. Levels are constructed for use in determining whether a surface or line is level and are never intended or configured to be measuring instruments; the measuring scale being merely added as a convenience to the user.

What is needed is a more rigid template for laying out such on-center locations, in both walls being built and in existing walls (upon finding the location of one of the wall studs, the ability to mark where the other studs should be located).

The present invention takes an existing construction tool, the spirit level, and adds to it graphics which allow a user to easily see the correct on-center placement locations for studs.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

The present invention is a carpentry tool comprising a body, at least one bubble (spirit) level means and first and second marking indicia marks.

The body generally parallelepipedal in shape, having a first end opposite a second end, a top level side opposite a bottom level side, and a front face side opposite a back face side. The top level side preferably comprising a measurement scale which sequentially increases in value from the first end to the second end.

The bubble level means mounted within the level body, the bubble device for indicating when a flat level side is oriented in a substantially horizontal position. The level bubble device viewable through the front face side.

The first marking indicia mark and a second marking indicia mark are located on the housing body front face. The first mark equidistant between the first end and the second mark. The second mark equidistant between the first mark and the second end. The length of the level body, in conjunction with these equally spaced marks, thus signifies to a user the desired on-center measurements of wall studs.

The purpose of the foregoing Abstract is to enable the United States Patent and Trademark Office and the public generally, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is a side view of one embodiment of the present invention.

FIG. 2 is an end view of the embodiment of FIG. 1.

FIG. 3 is a top view of the embodiment of FIG. 1.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

The present invention is an improved level for use in construction, particularly useful in the framing of building walls.

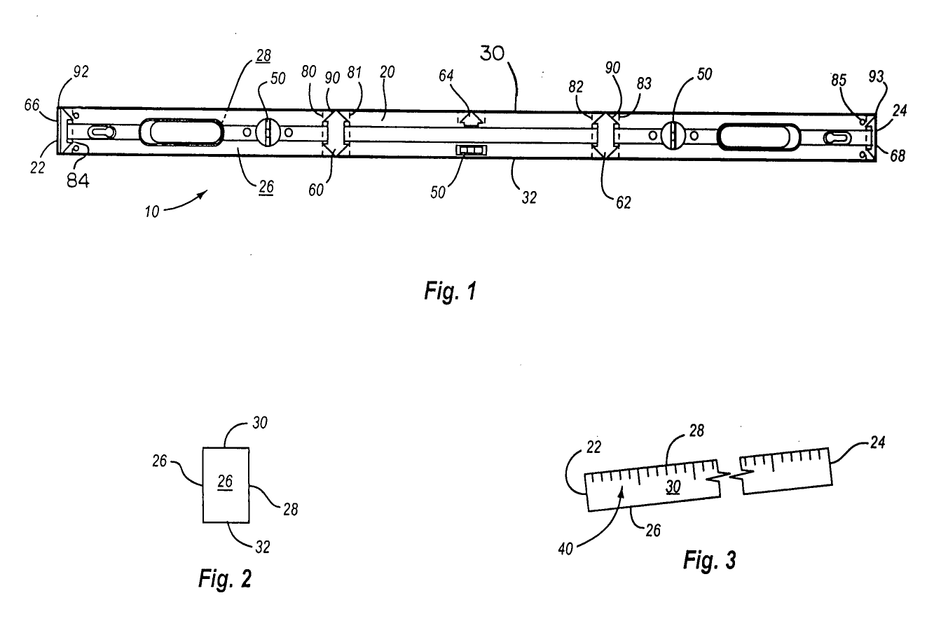

Referring to FIGS. 1-3, the preferred embodiment of this level 10 being of generally right rectangular or parallelepipedal shape, having a body so shaped. This generally “parallelepipedal shape” including all typical level shapes, including “I-beam” shaped levels and other levels that would fit in such a parallelepipedal shape (while not necessarily being “parallelepipedal” in their construction).

This body has a first end 22 that extends to a second end 24, a first face 26 opposite a second face 28, as well as a top side 30 opposite a bottom side 32. Such a configuration is common to construction levels.

Applied to one or both of the top side 30 and/or bottom side 32 is a measurement scale 40. This measurement scale 40 sequentially increasing in value from the first end 22 to the second end 24 (or vise versa). Such a top/bottom side having a measurement scale (imperial or metric units) thereon is common to construction levels.

The level or carpentry tool 10 including at least one level bubble device 50 therein. This level bubble device(s) for indicating when one of the flat level sides is in a substantially horizontal position. This level bubble device is viewable through said front face so that a user looking at the front face can view the bubble device and determine whether or not the level side (top or bottom) is level. While spirit (bubble) level means are typical, other mechanisms are also possible/exist in the prior art, including electronic level means, etc. Bubble level means are common in the prior art as a component of a construction level.

The carpentry tool or level 10 further comprises a plurality of marking indicia (60, 62) applied, preferably, to the first (front) face 26. The front face 26 being the face generally facing a user when the level 10 rests against a surface(s) to be marked. These marking indicia 60, 62 applied to the level body's front face (and/or back face) at a predetermined spacing. The first mark 60 and the second mark 62 can be stickers applied to the face, paint, engravings, etchings, etc.

It is preferred that two marks be provided, preferably being equidistant from one another and each mark being equidistant from the nearest end therefrom. Thus, the first mark 60 would be equidistant between the first end 22 and the second mark 62, whereas the second mark 62 will be equidistant between the second end 24 and the first mark 60. As such, these two marks divide the front face 26 of the level 10 into three different equally sized segments.

It is preferred that these equally sized segments or portions be equal to sixteen inches long (the standard on-center stud measurement for buildings in the United States). As such, application of two equidistant marks on a traditional four foot long (forty-eight inch) level would divide the level into three 16″ segments as defined by the first end (signifying the first stud), the first mark (signifying the second stud, which is on-center 16″ from the first stud), the second mark (signifying the third stud, which is on-center 16″ from the second stud), and the second end (signifying the fourth stud, which is on-center 16″ from the third stud) thereby totaling forty-eight (48) inches. While this is the preferred spacing and the preferred number of marks, obviously the present invention includes other embodiments and versions of this logic, including more marks and different spacing. The level's length may or may not take into consideration the utilization of end caps (the level may be forty-eight inches long with end caps or without end caps).

Another common “on-center” stud measurement is twenty-four (24) inches. Likewise, the present invention could be configured so as to accommodate 24-inch on-center, or any such measurement, studs.

It is preferred that these marking indicia be large so that a user can quickly and easily see the location of the on-center measurements. It is likewise preferred that measuring indicia be applied to both the first end 22 (a first end mark 66) and the second end 24 (a second end mark 68), to further reinforce the concept that the ends 22, 24 themselves signify on-center stud placement locations. Optionally, additional marking indicia could be applied to the center (equidistant from the first and second ends) for utilization by the user, i.e., the center mark 64 or at other locations.

Preferably, as shown in the drawings, these measuring indicia could be flanked by dotted lines 80/81, 82/83 or other indicia denoting the general stud width (typically 1.50 inches wide) of the stud whose center is signified by the measuring indicia. The center 90 of the arrow thus denoting the general center of the stud. These indicators of stud placement can thus be transferred as marks to the wall or other surfaces for assisting the user in determining the correct placement or location of the wall studs.

The half arrows 66, 68 on the ends 22, 24 likewise have centers 92, 93 which denote the general center of the respective end studs. These half arrows 66, 68 flanked by end lines (marking indicia), 85 preferably spaced 0.75 inches from the end of the level (which again, may or may not include the end cap width, some embodiments will have removable end caps, some embodiments could have the end caps as part of the end and/or arrow). Walls are typically built being 16″/24″ on-center, with the initial stud placed 16″/24″ inches from the corner of the exterior wall stud. Thus, the present invention can be used to start placing studs based upon an end or exterior wall stud's placement, with the end line 84 (85) used to determine the initial 16″/24″ on-center placement for the remainder of the wall.

Thus, in use, a user could set such a level onto a base plate (probably a two-by-four piece of dimensional lumber), marking off the on-center locations for the wall timbers to be installed. Once the wall timber on-center locations are marked, the wall can easily be assembled by attaching wall timbers (probably two-by-four pieces of dimensional lumber) to their respective on-center locations.

Another use is in marking the existing location of studs in wall. Presuming that one stud location is determined, the invented level 10 can be placed against the wall, aligning the known stud's center with one of the marks (or the end of the level), tilting the level until the level shows itself to be level in the spirit (bubble) level vials, and other stud on-center locations can be quickly and easily plotted at a glance.

Alternatively, both sixteen-inch and twenty-four-inch marking indicia could be on the same carpentry tool (level). For instance, on the same side or opposite sides of the level, or sixteen-inch marking indicia could be on the top portion of the front face with twenty-four-inch marking indicia on the bottom portion of the top face.

While the preferred embodiment of the present invention is discussed in Imperial measurement terms (inches and feet), the use of such non-metric measurement terminology is not intended to be exclusive but is done for simplification and reader convenience. As such, metric measurements (meters, centimeters, etc.) are considered within (for the purpose of this disclosure) the general terms “inches” and “feet.”

One manner of transferring these stud locations (center and/or edges) accurately is to, after determining the stud location using the present invention, carefully rotate the level along its length upon the wall surface ninety-degrees in either direction so that the arrow(s) is now pointing right at the wall surface (the top or bottom would thus be flush with the wall surface). At that point, marks can be transferred directly to the wall surface.

Common level lengths include 24-inches, 48-inches, 72-inches, 78-inches and 96-inches. However, other lengths are possible and the present invention could be applied or varied to be applied to any of these lengths. While the preferred embodiment presumes the use of a level length divisible by 16″ and/or 24″, it is expressly envisioned that this is not a limitation. The use of such easily divisible lengths work well with the present invention because the ends themselves can serve as additional marking indicia, signifying the locations of studs themselves. However, one could just as easily configure the present invention so that 16″/24″ on-center spacing starts at one end or the other, is generally centered, or is merely asymmetrically applied to the level. All of these embodiments are envisioned as equivalents to the present invention and are sub-embodiments.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

1. A carpentry tool comprising:
a generally parallelepipedal body having a first end opposite a second end, a top level side opposite a bottom level side and a front side face opposite a back side, said top level side comprising a measurement scale;
at least one level bubble device mounted within said level body for indicating when a level side is oriented in a substantially horizontal position, said level bubble device viewable through said front face; and
a plurality of marking indicia marks upon said housing body front face, said marking indicia marks sixteen-inches apart, said marking indicia thereby dividing said front face side into a plurality of generally sixteen-inch long segments;
wherein said marking indicia thus signify to a user the sixteen-inch on-center measurements of wall studs.

2. The carpentry tool of claim 1, wherein said tool comprises for each marking indicia:
a first stud marking indicia located between the marking indicia and the first end;
a second stud marking indicia located between the marking indicia and the second end; and,
said first stud marking indicia and said second stud marking indicia each located 0.750 of an inch from said marking indicia.

3. A carpentry tool comprising:
a generally parallelepipedal body having a first end opposite a second end, a top level side opposite a bottom level side and a front side face opposite a back side, said top level side comprising a measurement scale;
at least one level bubble device mounted within said level body for indicating when a level side is oriented in a substantially horizontal position, said level bubble device viewable through said front face; and
a plurality of marking indicia marks upon said housing body front face, said marking indicia marks twenty-four-inches apart, said marking indicia thereby dividing said front face side into a plurality of generally twenty-four-inch long segments;
wherein said marking indicia thus signify to a user the twenty-four-inch on-center measurements of wall studs.

4. The carpentry tool of claim 3, wherein said tool comprises for each marking indicia:
a first stud marking indicia located between the marking indicia and the first end;
a second stud marking indicia located between the marking indicia and the second end; and,
said first stud marking indicia and said second stud marking indicia each located 0.750 of an inch from said marking indicia.

5. A carpentry tool comprising:
a generally parallelepipedal body having a first end opposite a second end, a top level side opposite a bottom level side and a front side face opposite a back side, said top level side comprising a measurement scale, said body being generally forty-eight inches long;
at least one level bubble device mounted within said level body front side face for indicating when the top level side is oriented in a substantially horizontal position, said level bubble device viewable when viewing said front face side; and
first and second marking indicia marks on said housing body front face, said first marking indicia sixteen-inches from said first end, a second marking indicia sixteen-inches from said second end and sixteen-inches from said first marking indicia, said marking indicia thereby dividing said front face side into three sixteen inch long segments;
wherein said marking indicia thus signify to a user the on-center measurements of wall studs which are sixteen-inches on-center.

6. The carpentry tool of claim 5, further comprising at least six stud marking indicia on said housing body front face, said marking indicia comprising:
a first stud marking indicia located between said first end and said first marking indicia, said first stud marking indicia located 0.750 of an inch from said first end;
a second stud marking indicia located between said first end and said first marking indicia, said second stud marking indicia located 0.750 of an inch from said first marking indicia;
a third stud marking indicia located between said first marking indicia and said second marking indicia, said third stud marking indicia located 0.750 of an inch from said first marking indicia;
a fourth stud marking indicia located between said first marking indicia and said second marking indicia, said fourth stud marking indicia located 0.750 of an inch from said second marking indicia;
a fifth stud marking indicia located between said second marking indicia and said second end, said fifth stud marking indicia located 0.750 of an inch from said second marking indicia;
a sixth stud marking indicia located between said second marking indicia and said second end, said twelfth stud marking indicia located 0.750 of an inch from said second end.

7. The carpentry tool of claim 5, wherein said first and second ends each comprise marking indicia.

8. A carpentry tool comprising:
a generally parallelepipedal body having a first end opposite a second end, a top level side opposite a bottom level side and a front side face opposite a back side, said top level side comprising a measurement scale, said body being generally forty-eight inches long;
at least one level bubble device mounted within said level body front side face for indicating when the top level side is oriented in a substantially horizontal position, said level bubble device viewable when viewing said front face side; and
a first marking indicia mark on said housing body front face, said first marking indicia twenty-four-inches from said first end and twenty-four-inches from said second end, said marking indicia thereby dividing said front face side into two twenty-four-inch long segments;
wherein said marking indicia thus signifies to a user the on-center measurements of wall studs which are twenty-four-inches on-center.

9. The carpentry tool of claim 8, further comprising at least four stud marking indicia on said housing body front face, said marking indicia comprising:
a first stud marking indicia located between said first end and said first marking indicia, said first stud marking indicia located 0.750 of an inch from said first end;
a second stud marking indicia located between said first end and said first marking indicia, said second stud marking indicia located 0.750 of an inch from said first marking indicia;
a third stud marking indicia located between said first marking indicia and said second end, said third stud marking indicia located 0.750 of an inch from said first marking indicia;
a fourth stud marking indicia located between said first marking indicia and said second end, said fourth stud marking indicia located 0.750 of an inch from said second end.

10. The carpentry tool of claim 8, wherein said first and second ends each comprise marking indicia.

11. A carpentry tool comprising:
a generally parallelepipedal body having a first end opposite a second end, a top level side opposite a bottom level side and a front side face opposite a back side, said top level side comprising a measurement scale, said body being generally ninety-six inches long;
at least one level bubble device mounted within said level body front side face for indicating when the top level side is oriented in a substantially horizontal position, said level bubble device viewable when viewing said front face side; and
a plurality of marking indicia marks on said housing body front face, a first marking indicia sixteen-inches from said first end, a second marking indicia sixteen-inches from said first marking indicia and sixteen-inches from a third marking indicia, a third marking indicia sixteen-inches from said second marking indicia and sixteen-inches from a fourth marking indicia, a fourth marking indicia sixteen-inches from said third marking indicia and sixteen-inches from a fifth marking indicia, and a fifth marking indicia sixteen-inches from said fourth marking indicia and sixteen-inches from said second end, said marking indicia thereby dividing said front face side into six sixteen-inch long segments;
wherein said marking indicia thus signify to a user the on-center measurements of wall studs which are sixteen-inches on-center.

12. The carpentry tool of claim 11, further comprising at least twelve stud marking indicia on said housing body front face, said marking indicia comprising:
a first stud marking indicia located between said first end and said first marking indicia, said first stud marking indicia located 0.750 of an inch from said first end;
a second stud marking indicia located between said first end and said first marking indicia, said second stud marking indicia located 0.750 of an inch from said first marking indicia;
a third stud marking indicia located between said first marking indicia and said second marking indicia, said third stud marking indicia located 0.750 of an inch from said first marking indicia;
a fourth stud marking indicia located between said first marking indicia and said second marking indicia, said fourth stud marking indicia located 0.750 of an inch from said second marking indicia;
a fifth stud marking indicia located between said second marking indicia and a third marking indicia, said fifth stud marking indicia located 0.750 of an inch from said second marking indicia;
a sixth stud marking indicia located between said second marking indicia and a third marking indicia, said sixth stud marking indicia located 0.750 of an inch from said third marking indicia;
a seventh stud marking indicia located between said third marking indicia and a fourth marking indicia, said seventh stud marking indicia located 0.750 of an inch from said third marking indicia;
an eighth stud marking indicia located between said third marking indicia and a fourth marking indicia, said eighth stud marking indicia located 0.750 of an inch from said fourth marking indicia;
a ninth stud marking indicia located between said fourth marking indicia and a fifth marking indicia, said ninth stud marking indicia located 0.750 of an inch from said fourth marking indicia;
a tenth stud marking indicia located between said fourth marking indicia and a fifth marking indicia, said tenth stud marking indicia located 0.750 of an inch from said fifth marking indicia;
an eleventh stud marking indicia located between said fifth marking indicia and said second end, said eleventh stud marking indicia located 0.750 of an inch from said fifth marking indicia;
a twelfth stud marking indicia located between said fifth marking indicia and said second end, said twelfth stud marking indicia located 0.750 of an inch from said second end.

13. The carpentry tool of claim 11, wherein said first and second ends each comprise marking indicia.

14. A carpentry tool comprising:
a generally parallelepipedal body having a first end opposite a second end, a top level side opposite a bottom level side and a front side face opposite a back side, said top level side comprising a measurement scale, said body being generally ninety-six inches long;
at least one level bubble device mounted within said level body front side face for indicating when the top level side is oriented in a substantially horizontal position, said level bubble device viewable when viewing said front face side; and
a plurality of marking indicia marks on said housing body front face, a first marking indicia twenty-four-inches from said first end and twenty-four-inches from a second marking indicia, a second marking indicia twenty-four-inches from said first marking indicia and twenty-four-inches from a third marking indicia, a third marking indicia twenty-four-inches from said second marking indicia and twenty-four-inches from said second end, said marking indicia thereby dividing said front face side into four twenty-four-inch long segments;
wherein said marking indicia thus signify to a user the on-center measurements of wall studs which are twenty-four-inches on-center.

15. The carpentry tool of claim 14, further comprising at least six stud marking indicia on said housing body front face, said marking indicia comprising:
a first stud marking indicia located between said first end and said first marking indicia, said first stud marking indicia located 0.750 of an inch from said first end;
a second stud marking indicia located between said first end and said first marking indicia, said second stud marking indicia located 0.750 of an inch from said first marking indicia;
a third stud marking indicia located between said first marking indicia and said second marking indicia, said third stud marking indicia located 0.750 of an inch from said first marking indicia;
a fourth stud marking indicia located between said first marking indicia and said second marking indicia, said fourth stud marking indicia located 0.750 of an inch from said second marking indicia;
a fifth stud marking indicia located between said second marking indicia and said second end, said fifth stud marking indicia located 0.750 of an inch from said second marking indicia;
a sixth stud marking indicia located between said second marking indicia and said second end, said twelfth stud marking indicia located 0.750 of an inch from said second end.

16. The carpentry tool of claim 15, wherein said first and second ends each comprise marking indicia.

17. A carpentry tool comprising:
a generally parallelepipedal body having a first end opposite a second end, a top level side opposite a bottom level side and a front side face opposite a back side, said top level side comprising a measurement scale, said body being generally seventy-two inches long;
at least one level bubble device mounted within said level body front side face for indicating when the top level side is oriented in a substantially horizontal position, said level bubble device viewable when viewing said front face side; and
a plurality of marking indicia marks on said housing body front face, a first marking indicia twenty-four-inches from said first end and twenty-four-inches from a second marking indicia, a second marking indicia twenty-four-inches from said first marking indicia and twenty-four-inches from said second end, said marking indicia thereby dividing said front face side into three twenty-four-inch long segments;
wherein said marking indicia thus signify to a user the on-center measurements of wall studs which are twenty-four-inches on-center.

18. The carpentry tool of claim 17, further comprising at least six stud marking indicia on said housing body front face, said marking indicia comprising:
a first stud marking indicia located between said first end and said first marking indicia, said first stud marking indicia located 0.750 of an inch from said first end;
a second stud marking indicia located between said first end and said first marking indicia, said second stud marking indicia located 0.750 of an inch from said first marking indicia;
a third stud marking indicia located between said first marking indicia and said second marking indicia, said third stud marking indicia located 0.750 of an inch from said first marking indicia;
a fourth stud marking indicia located between said first marking indicia and said second marking indicia, said fourth stud marking indicia located 0.750 of an inch from said second marking indicia;
a fifth stud marking indicia located between said second marking indicia and said second end, said fifth stud marking indicia located 0.750 of an inch from said second marking indicia;
a sixth stud marking indicia located between said second marking indicia and said second end, said twelfth stud marking indicia located 0.750 of an inch from said second end.

19. The carpentry tool of claim 17, wherein said first and second ends each comprise marking indicia.
